(19) United States
(12) Patent Application Publication
(10) Pub. No.: US 2013/0152854 A1
(43) Pub. Date: Jun. 20, 2013

(54) THERMAL GREASE SMEARING APPARATUS

(71) Applicants: WEI-MIN QIN, Wuhan City (CN); CHANG-JUN LI, Wuhan City (CN); YU-LIN LIU, Wuhan City (CN)

(72) Inventors: WEI-MIN QIN, Wuhan City (CN); CHANG-JUN LI, Wuhan City (CN); YU-LIN LIU, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/467,123

(22) Filed: May 9, 2012

(30) Foreign Application Priority Data
Dec. 20, 2011 (CN) 201110429463.6

(51) Int. Cl. B05C 11/04; B05C 13/02

(52) U.S. Cl. 118/111

(57) ABSTRACT

A thermal grease smearing apparatus includes a platform for placing a heat sink, a supporting post projecting from the platform, and a bracket mounted to the supporting post. The bracket includes a bottom plate with a smearing hole. A thermal grease pipe is mounted to the bracket and includes a pipe body having an upper opening for introducing thermal grease and a lower opening for applying the thermal grease onto a bottom surface of the heat sink. When the bracket is positioned in a working position, the bottom surface aligns with a the smearing hole and abuts a lower surface of the bottom plate, a smearing portion contacts with the thermal grease applied onto the bottom surface and is actuated to rotate about a central axis of the thermal grease pipe thereby smearing the thermal grease uniformly spread on the bottom surface of the heat sink.

### BACKGROUND

1. Technical Field

The present disclosure generally relates to a thermal grease smearing apparatus, and particularly relates to a thermal grease smearing apparatus for applying thermal grease to a bottom surface of a heat sink.

2. Description of Related Art

Electronic components, such as central processing units (CPUs) in computers may generate a lot of heat during normal operation. Excess heat may deteriorate operational stability of the electronic components and may damage the electronic components. Thus, excess heat must be removed quickly to maintain an acceptable operating temperature of the electronic components in the computers. One known method for removing heat from an electronic component is by mounting a heat sink on the electronic component. A layer of thermal grease is usually spread on a bottom surface of the heat sink to improve heat conductivity between the heat sink and the electronic component. However, it may not be easy to apply a layer of thermal grease uniformly on the bottom surface of the heat sink.

Therefore, a need may be desired to provide a thermal grease smearing apparatus which can conveniently and uniformly smear a layer of thermal grease on a bottom surface of a heat sink.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a thermal grease smearing apparatus in accordance with an embodiment.

FIG. 2 is an assembled view of the thermal grease smearing apparatus of FIG. 1.

FIG. 3 is similar to FIG. 5, but viewed from a different aspect, showing a heat sink on a platform of the thermal grease smearing apparatus.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

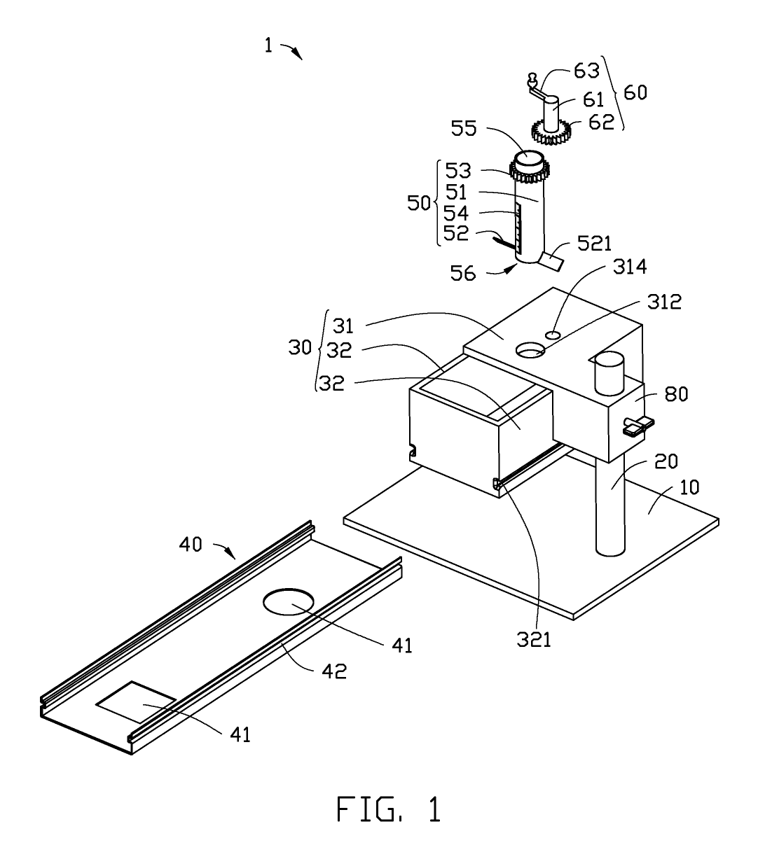

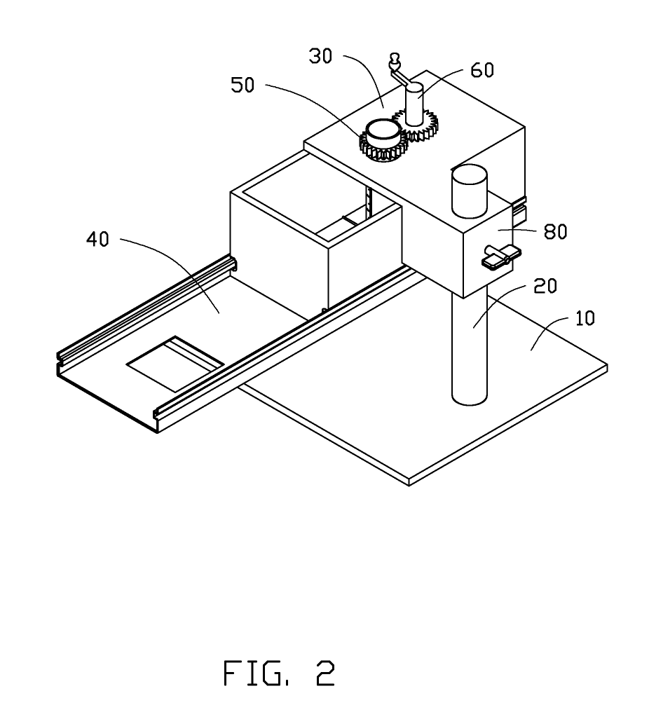

FIGS. 1-3, show a thermal grease smearing apparatus 1 in accordance with an embodiment capable of applying thermal grease on a bottom surface 71 of a heat sink 70. The bottom surface 71 may contact with a top surface of an electronic heat-generating component (not shown), such as a central processing unit (CPU), and receive heat from the electronic heat-generating component. The thermal grease smearing apparatus 1 includes a platform 10, a supporting post 20, a bracket 30, a thermal grease pipe 50, a driving member 60, and a shifting mechanism 80.

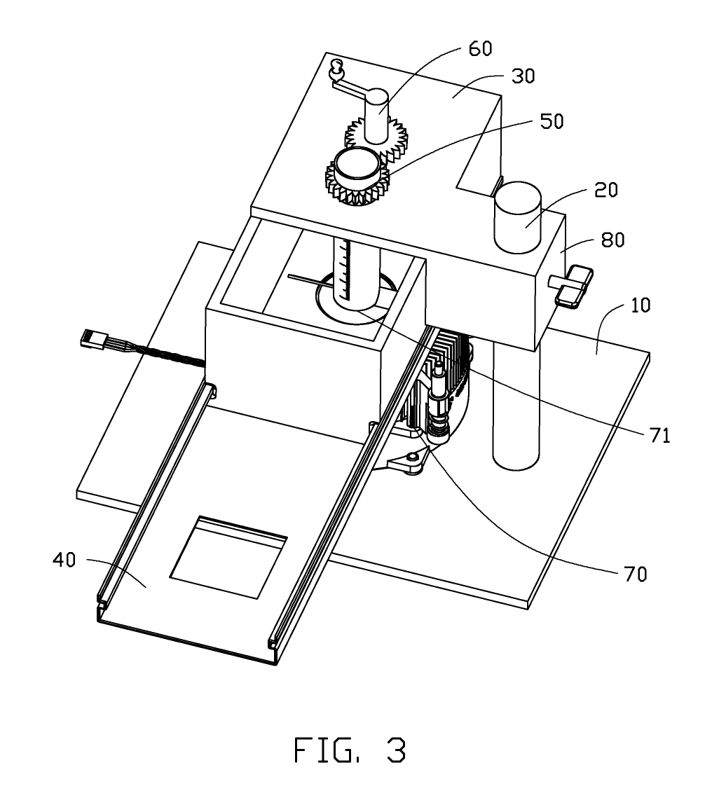

The heat sink 70 can be placed upside down on the platform 10 so that the bottom surface 71 of the heat sink 70 faces up, as shown in FIG. 3.

The supporting post 20 projects upwardly from the platform 10 and is substantially perpendicular to the platform 10. In one embodiment, the supporting post 20 may be a cylinder with a circular cross-section. The supporting post 20 is secured to the platform by welding or other means. If desired, however, the supporting post 20 could be die-cast integrally with the platform 10.

The bracket 30 includes a top plate 31, a bottom plate 40, and two opposite sidewalls 32. The top plate 31 defines a first through hole 312 and a second through hole 314. The first through hole 312 is adjacent to the second through hole 314. The bottom plate 40 defines at least one smearing hole 41. The at least one smearing hole 41 may be defined in a variety shapes, such as a rectangle and a circle. An appropriate shape of the at least one smearing hole 41 can be selected up to the shape of the bottom surface 71 of the heat sink 70.

The bottom plate 40 is slidably coupled to the two opposite sidewalls 32. Each of the two opposite sidewalls 32 defines a sliding groove 321 on an exterior side thereof. The bottom plate 40 comprises two sliding rails 42. The two sliding rails 42 may be received respectively in each of the sliding grooves 321 and engaged with each of the sliding grooves 321 such that the bottom plate 40 is mounted to the two opposite sidewalls 32 and is able to move slidably relative to the two opposite sidewalls 32. An appropriate shape of the at least one smearing hole 41 can be selected and aligned with the bottom surface 71 of the heat sink 70 by sliding the bottom plate 40 relative to the two opposite sidewalls 32.

The shifting mechanism 80 extends laterally from one of the two sidewalls 32.

The shifting mechanism 80 includes a receiving hole (not labeled). The receiving hole receives and surrounds the supporting post 20 thereby mounting the bracket 30 to the supporting post 20 and enabling variable positioning of the bracket 30 relative to the platform 10. The shifting mechanism 80 may be actuated to lift up or down the bracket 30 along the supporting post 20 and fix the bracket 30 in a desired position.

The thermal grease pipe 50 includes a pipe body 51, a smearing portion 52, and a driven gear 53. The pipe body 51 is a hollow pipe formed with an upper opening 55 and a lower opening 56. The thermal grease can be input into the upper opening 55 and guided by the pipe body 51 and then applied onto the bottom surface 71 of the heat sink 70. The pipe body 51 is received in the first through hole 312 and mounted to the top plate 31 of the bracket 30. The upper opening 55 is defined in the outside of the bracket 30 and the lower opening 56 is defined in the inside of the bracket 30. In some embodiments, the pipe body 51 may be made from transparent material, for example glass or plastic. A scale 54 may be marked on an exterior surface of the pipe body 51 to indicate a volume of the thermal grease that has been introduced into the pipe body 51 of the thermal grease pipe 50. The driven gear 62 surrounds the pipe body and is arranged outside of the bracket 30.

The smearing portion 52 is arranged at the lower end of the pipe body 51 and adjacent to the lower opening 56. The smearing portion 52 includes two opposite propeller blades 521. Each of the two propeller blades 521 has an edge inclined to and close to the bottom plate 40 of the bracket 30.

The driving member 60 comprises a cylindrical body 61, a driving gear 62, and an operating handle 63. The cylindrical body 61 is received in the second through hole 314 thereby mounting the driving member 60 to the top plate 31. The driving gear 62 surrounds the cylindrical body 61 and is arranged outside of the bracket 30. The operating handle 63 extends laterally from the cylindrical body 61 and is operable to drive the cylindrical body 61 to rotate about its own central axis thereby rotating the driving gear 62 to drive the driven gear 53 to rotate about a central axis of the thermal grease pipe 50.

Referring to FIG. 3, when in use, the heat sink 70 is placed on the platform 10 and beneath the bracket 30. The bottom surface 71 of the heat sink 70 faces up. According to the shape of the bottom surface 71, an appropriate shape of the at least one smearing hole 41 is selected and moved to a position aligned with the bottom surface 71 of the heat sink 70 by sliding the bottom plate 40 relative to the two opposite sidewalls 32. The center of the smearing portion 52 is aligned with the center of the selected one of the at least one smearing hole 41.

The shifting mechanism 80 is actuated to lift the bracket 30 along the supporting post 20 and fix the bracket 30 in a working position such that the bottom surface 71 of the heat sink 70 abuts the lower surface of the bottom plate 40 and exposes its central portion accessible to the selected one of the at least one smearing hole 41. A certain volume of thermal grease is input into the pipe body 51 of the thermal grease pipe 50 from the upper opening and guided by the pipe body 51 and then applied to the bottom surface 71 of the heat sink 70 from the lower opening. The smearing portion 52 is in contact with the thermal grease applied onto the bottom surface 71.

The operating handle 63 is actuated to drive the driving gear 62 to rotate about the central axis of the cylindrical body 61 thereby rotating the driven gear 53 to drive the smearing portion 52 to rotate about the central axis of the thermal grease pipe 50. The thermal grease is uniformly spread on the bottom surface 71 of the heat sink 70 as a result of the rotation of the smearing portion 52 performed on the bottom surface 71.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A thermal grease smearing apparatus, comprising:
a platform configured to receive a heat sink with a bottom surface of the heat sink facing up;
a supporting post projecting upwardly from the platform;
a bracket mounted to the supporting post and being adapted to be positioned in various positions relative to the platform, the bracket comprising a bottom plate formed with at least one smearing hole, and a top plate defining a first through hole; and
a thermal grease pipe received in the first through hole and mounted to the top plate of the bracket, the thermal grease pipe comprising a pipe body comprising an upper opening for introducing thermal grease, a lower opening for applying the thermal grease onto the bottom surface of the heat sink, and a smearing portion adjacent to the lower opening,
wherein when the bracket is positioned in a working position, a selected one of the at least one smearing hole is aligned with the bottom surface of the heat sink, a lower surface of the bottom plate abuts the bottom surface of the heat sink, and the smearing portion is adapted to rotate about a central axis of the thermal grease pipe and to smear the thermal grease uniformly on the bottom surface of the heat sink.

2. The thermal grease smearing apparatus of claim 1, further comprising a shifting mechanism configured to mount the bracket to the supporting post, the shifting mechanism is adapted to adjust the height of the bracket relative to the platform.

3. The thermal grease smearing apparatus of claim 2, wherein the shifting mechanism defines a receiving hole configured to receive and to surround the supporting post.

4. The thermal grease smearing apparatus of claim 1, further comprising a driving member adapted to drive the thermal grease pipe to rotate thereby driving the smearing portion to rotate about the central axis of the thermal grease pipe.

5. The thermal grease smearing apparatus of claim 4, wherein the driving member comprises a cylindrical body, the top plate further defines a second through hole configured to receive the cylindrical body.

6. The thermal grease smearing apparatus of claim 5, wherein the thermal grease pipe further comprises a driven gear surrounding the pipe body, the driving member further comprises a driving gear surrounding the cylindrical body, the driving gear is engaged with the driven gear to drive the thermal grease pipe to rotate.

7. The thermal grease smearing apparatus of claim 6, wherein the driving member further comprises an operating handle extending laterally from the cylindrical body, the operating handle is operable to rotate the cylindrical body thereby rotating the driving gear.

8. The thermal grease smearing apparatus of claim 1, wherein the pipe body of the thermal grease pipe is made from a transparent material, a scale is marked on an exterior surface of the pipe body to indicate a volume of the thermal grease.

9. The thermal grease smearing apparatus of claim 1, wherein the smearing portion comprises two propeller blades, each of the two propeller blades defines an edge inclined to the bottom plate of the bracket.

10. The thermal grease smearing apparatus of claim 1, wherein the bracket further comprises two opposite sidewalls, the bottom plate is slidably coupled to each of the two opposite sidewalls.

11. The thermal grease smearing apparatus of claim 10, wherein each of the two opposite sidewalls defines a sliding groove on an exterior side thereof, the bottom plate comprises two sliding rails, each of the two sliding rails being engaged with each of the two sliding grooves so that the bottom plate is slidable relative to the two opposite sidewalls.

12. The thermal grease smearing apparatus of claim 11, wherein the bottom plate is adapted to slide along the two opposite sidewalls to select one of the at least one smearing hole.

13. A thermal grease smearing apparatus for smearing thermal grease on a bottom surface of a heat sink, the thermal grease smearing apparatus comprising:
a platform configured to receive a heat sink;
a supporting post projecting upwardly from the platform;
a bracket comprising a bottom plate defining with at least one smearing hole, and a top plate defining a through hole;
a shifting mechanism extending laterally from the bracket, the shifting mechanism adapted to mount the bracket to the supporting post and to adjust a height <I accept.> of the bracket relative to the platform;
a thermal grease pipe received in the through hole and mounted to the top plate of the bracket, the thermal grease pipe comprising a pipe body comprising an upper opening for introducing thermal grease, a lower opening for applying the thermal grease onto the bottom surface of the heat sink, and a smearing portion adjacent to the lower opening;
when the bracket is positioned in a working position, a selected one of the at least one smearing hole is aligned with the bottom surface of the heat sink, a lower surface of the bottom plate abuts the bottom surface of the heat sink, and the smearing portion is adapted to rotate about a central axis of the thermal grease pipe and to smear the thermal grease uniformly on the bottom surface of the heat sink.

14. The thermal grease smearing apparatus of claim 13, further comprising a driving member adapted to drive the thermal grease pipe to rotate thereby driving the smearing portion to rotate about the central axis of the thermal grease pipe.

15. The thermal grease smearing apparatus of claim 14, wherein the driving member comprises a cylindrical body, the top plate further defines a second through hole configured to receive the cylindrical body.

16. The thermal grease smearing apparatus of claim 15, wherein the thermal grease pipe further comprises a driven gear surrounding the pipe body, the driving member further comprises a driving gear surrounding the cylindrical body, the driving gear is engaged with the driven gear to drive the thermal grease pipe to rotate.

17. The thermal grease smearing apparatus of claim 16, wherein the driving member further comprises an operating handle extending laterally from the cylindrical body, the operating handle is operable to rotate the cylindrical body thereby rotating the driving gear.

18. The thermal grease smearing apparatus of claim 13, wherein the smearing portion comprises two propeller blades, each of the two propeller blades defines an edge inclined to the bottom plate of the bracket.

19. The thermal grease smearing apparatus of claim 13, wherein the bracket further comprises two opposite sidewalls, each of the two opposite sidewalls defines a sliding groove on an exterior side thereof, the bottom plate comprises two sliding rails, each of the two sliding rails being engaged with each of the two sliding grooves so that the bottom plate is slidable relative to the two opposite sidewalls.

20. The thermal grease smearing apparatus of claim 19, wherein the bottom plate is adapted to slide along the two opposite sidewalls to select one of the at least one smearing hole.
